(19) United States
(12) Patent Application Publication
(10) Pub. No.: US 2008/0027580 A1
(43) Pub. Date: Jan. 31, 2008

(54) Robot programming method and apparatus with both vision and force

(76) Inventors: Hui Zhang, West Hartford, CT (US); Jianjun Wang, West Hartford, CT (US); Heping Chen, Manchester, CT (US)

Correspondence Address: Michael M. Rickin, Esq.;ABB Inc., Legal Department - 4U6, 29801 Euclid Avenue, Wickliffe, OH, 44092-1832, US

(21) Appl. No.: 11/495,016

(22) Filed: Jul. 28, 2006

(51) Int. Cl. G06F 19/00

(52) U.S. Cl. 700/245

(57) ABSTRACT

Both vision and force control are used to program a robot so that a tool having a tip can follow a desired path visibly marked on a workpiece when the tool is to perform work on the workpiece. There is a force sensor, a camera positioned to view the visibly marked path and a computing device. When the tool tip is in controlled contact with an area of the workpiece that includes the desired path, the camera and the force sensor each provide information to the computing device. The information is used to develop a program to move the robot to cause the tool tip to follow the desired path when the tool is to perform work on the workpiece. The tool can move in relation to the workpiece and the camera is mounted on the robot or the workpiece moves in relation to the stationary camera and tool.

### FIELD OF THE INVENTION

This invention relates to robots and more particularly to an automated robot programming method combining both visual and tactile information.

### DESCRIPTION OF THE PRIOR ART

Robots prefer a tidy, orderly world to a messy one.

But, in many cases, messy is what they're given. Robotics engineers refer to this place as the unstructured environment. It is everywhere, from the rubble-strewn surface of Mars to the back flaps of a supermarket loading dock. Nothing is where it is supposed to be, which renders today's industrial robot incapable of operating in those settings.

To make the robot carry out a given task as intended even in a structured environment, whether that task is welding, polishing or deburring, usually requires a person to “teach” or “program” the robot manually. The manual teaching entails moving the robot into a number of successive positions/orientations in the workspace. This necessary step is mainly due to the fact that the robot lacks a human's understanding of a task and the human's ease in identifying key surfaces.

To this end, there have been numerous efforts and methods to facilitate and make the teaching step easier and eventually automated. One such system is described in U.S. Pat. No. 5,959,425 (“the '425 Patent”), wherein a vision guided automated robotic path teaching method is 30 disclosed. Most of the existing vision guided path teaching methods can be categorized as the calibration-and-servo method of robot control, for which an accurate calibration between the camera coordinate system and robot coordinate system has to be realized. To achieve three-dimensional coordinate information out of two-dimension images acquired from a camera, usually requires acquiring images from multiple perspectives, either through stereo vision or by moving the camera to multiple locations. In the case when the surface orientation needs to be determined, there is not yet a practical system to make that determination.

Essentially, all cameras are 2-D imaging devices.

In all existing vision guided automated robotic path learning systems such as that disclosed in the '425 Patent, this type of 2-D device is used for 3-D metrology by various proposed techniques such as the calibration and servo technique described below. Because of requirements for high quality camera and accurate calibrations, the existing systems are costly, error prone and not robust enough for daily use at the workshop.

Essentially, the calibration-and-servo method is similar to asking a person to first use his eyes to determine the absolute coordinates of a needle and thread in space, then close his eyes and rely on the knowledge of his limb length and joint angles alone to actually thread the needle. That's not how a human threads a needle. Instead, he moves his joints and observes the motions and positions of the two objects as they come together.

The present invention reduces the high requirements on calibration and the camera itself by combining visual and force feedback in a synergistic approach to obtain three dimensions (six degree-of-freedom, including position and orientation) coordinate information. The present invention can be termed a vision-force-servo method, to differentiate it from the techniques of the prior art. Thus, by using the present invention, the teaching of the robot can be automated with an easy to maintain, robust and cost effective system.

### SUMMARY OF THE INVENTION

A system for programming a robot so that a tool having a tip can follow a desired path visibly marked on a workpiece when said tool is to perform work on said workpiece. The system has:

a force sensor;

a camera oriented to view said visibly marked desired path; and

a computing device associated with said robot;

said force sensor and said camera each providing information to said computing device when said tool tip is in controlled contact with an area of said workpiece that includes said desired path, said computing device using said information to develop a program for motion of said robot that causes said tool tip to follow said desired path when said tool is to perform work on said workpiece.

A method for programming a robot so that a tool having a tip can follow a desired path visibly marked on a workpiece when said tool is to perform work on said workpiece. The method:

uses an image of a point on said desired path when said tool tip is on said desired path and one or more other points related to said point on said desired path when said tool tip is in controlled contact with an area on said workpiece that includes said desired path to determine a predetermined number of degrees of freedom information for said point on said desired path; repeats said step above to determine said predetermined number of degrees of freedom information for one or more other points on said desired path; and

develops from said determined predetermined number of degrees of freedom information for said point on said desired path and each of said one or more other points on said desired path a program for motion of said robot that allows said tool tip to follow said desired path when said tool is to perform work on said workpiece.

A method for programming a robot so that a tool having a tip can follow a desired path visibly marked on a workpiece when said tool is to perform work on said workpiece. The method:

determines from an image of each of a plurality of points on said desired path when said tool tip is on said desired path and is in controlled contact with said workpiece the X, Y and Z locations of each of said plurality of points on said desired path and the roll angle of said tool with said desired path at each of said plurality of points;

uses each of said plurality of points on said desired path and one or more other points related to each of said plurality of points on said desired path when said tool tip is in controlled contact with an area on said workpiece related to said desired path to determine the pitch and yaw angles of said tool with said desired path for each of said plurality of points on said desired path; and

develops from said X, Y and Z locations and said roll, pitch and yaw angles for each of plurality of points on said desired path a program for motion of said robot that allows said tool tip to follow said desired path when said tool is to perform work on said workpiece.

A computer program product for programming a robot so that a tool having a tip can follow a desired path visibly marked on a workpiece when said tool is to perform work on said workpiece. The computer program product has:

a computer-readable medium having instructions for causing a computer to execute a method. The method:

uses an image of a point on said desired path when said tool tip is on said desired path and one or more other points related to said point on said desired path when said tool tip is in controlled contact with an area on said workpiece that includes said desired path to determine a predetermined number of degrees of freedom information for said point on said desired path;

repeats said step above to determine said predetermined number of degrees of freedom information for one or more other points on said desired path; and

develops from said determined predetermined number of degrees of freedom information for said point on said desired path and each of said one or more other points on said desired path a program for motion of said robot that allows said tool tip to follow said desired path when said tool is to perform work on said workpiece.

A computer program product for programming a robot so that a tool having a tip can follow a desired path visibly marked on a workpiece when said tool is to perform work on said workpiece. The computer program product has:

a computer-readable medium having instructions for causing a computer to execute a method. The method:

determines from an image of each of a plurality of points on said desired path when said tool tip is on said desired path and is in controlled contact with said workpiece the X, Y and Z locations of each of said plurality of points on said desired path and the roll angle of said tool with said desired path at each of said plurality of points;

uses each of said plurality of points on said desired path and one or more other points related to each of said plurality of points on said desired path when said tool tip is in controlled contact with an area on said workpiece related to said desired path to determine the pitch and yaw angles of said tool with said desired path for each of said plurality of points on said desired path; and

develops from said X, Y and Z locations and said roll, pitch and yaw angles for each of plurality of points on said desired path a program for motion of said robot that allows said tool tip to follow said desired path when said tool is to perform work on said workpiece.

A system for programming a robot so that a tool having a tip can follow a desired path visibly marked on a workpiece when said tool is to perform work on said workpiece. The system has:

a computing device having therein program code usable by said computing device. The program code has:

code configured to use an image of a point on said desired path when said tool tip is on said desired path and one or more other points related to said point on said desired path when said tool tip is in controlled contact with an area on said workpiece that includes said desired path to determine a predetermined number of degrees of freedom information for said point on said desired path; code configured to repeat said step above to determine said predetermined number of degrees of freedom information for one or more other points on said desired path; and

code configured to develop from said determined predetermined number of degrees of freedom information for said point on said desired path and each of said one or more other points on said desired path a program for motion of said robot that allows said tool tip to follow said desired path when said tool is to perform work on said workpiece.

A system for programming a robot so that a tool having a tip can follow a desired path visibly marked on a workpiece when said tool is to perform work on said workpiece. The system has:

a computing device having therein program code usable by said computing device. The program code has:

code configured to determine from an image of each of a plurality of points on said desired path when said tool tip is on said desired path and is in controlled contact with said workpiece the X, Y and Z locations of each of said plurality of points on said desired path and the roll angle of said tool with said desired path at each of said plurality of points;

code configured to use each of said plurality of points on said desired path and one or more other points related to each of said plurality of points on said desired path when said tool tip is in controlled contact with an area on said workpiece related to said desired path to determine the pitch and yaw angles of said tool with said desired path for each of said plurality of points on said desired path; and

code configured to develop from said X, Y and Z locations and said roll, pitch and yaw angles for each of plurality of points on said desired path a program for motion of said robot that allows said tool tip to follow said desired path when said tool is to perform work on said workpiece.

### DESCRIPTION OF THE DRAWING

FIG. 1 shows a typical robot system which can use the present invention.

FIG. 2 shows an expanded view of the robot arm, force sensor, tool, camera and the marked feature of FIG. 1 along with an expanded view of the X and Y axes and the roll angle of the tool with the marked feature.

FIG. 3 also shows an expanded view of the robot arm, force sensor, tool, camera and the marked feature of FIG. 1 along with the normal direction of a plane formed by the points that neighbor the feature path.

FIG. 4 shows a first technique for obtaining the pitch and yaw orientation of the tool with the feature path.

FIG. 5 shows the mathematical expression used by in the present invention to transfer the actual position or orientation errors of the tool with the feature path into the robot velocity in the tool coordinate frame.

FIGS. 6-1 and 6-2 show control diagrams that illustrate the process using the technique of Fog. 4 for obtaining the final path to be followed by the tool when the tip is to perform work on the workpiece.

FIG. 7 shows a second technique for obtaining the pitch and yaw orientation of the tool with the feature path.

FIG. 8 shows the control diagram that illustrates the technique of FIG. 7.

FIG. 9 shows a block diagram for a system that may be used to implement the automated path learning method of the present invention.

### DETAILED DESCRIPTION

As described above, the present invention provides a low cost, reliable and autonomous method to acquire a predetermined number of degrees of freedom coordinate information so that a robot under such control method can program itself given that the desired path is visibly marked. While the embodiment of the present invention described herein has six as the predetermined number of degrees of freedom coordinate information that is only one example of the predetermined number of degrees of freedom coordinate information that may be used with the present invention and is not meant to limit the applicability of the present invention as those skilled in the art can readily ascertain after reading the description herein that other degrees of freedom coordinate information can be used with the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, the present invention may take the form of a computer program product on a computer-usable or computer-readable medium having computer-usable program code embodied in the medium. The computer-usable or computer-readable medium may be any medium that can contain, store, communicate, propagate, or transport the program for use by or in connection with the instruction execution system, apparatus, or device and may by way of example but without limitation, be an electronic, magnetic, optical, electromagnetic, infrared, or semiconductor system, apparatus, device, or propagation medium or even be paper or other suitable medium upon which the program is printed. More specific examples (a non-exhaustive list) of the computer-readable medium would include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Computer program code for carrying out operations of the present invention may be written in an object oriented programming language such as Java, Smalltalk, C++ or the like, or may also be written in conventional procedural programming languages, such as the “C” programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

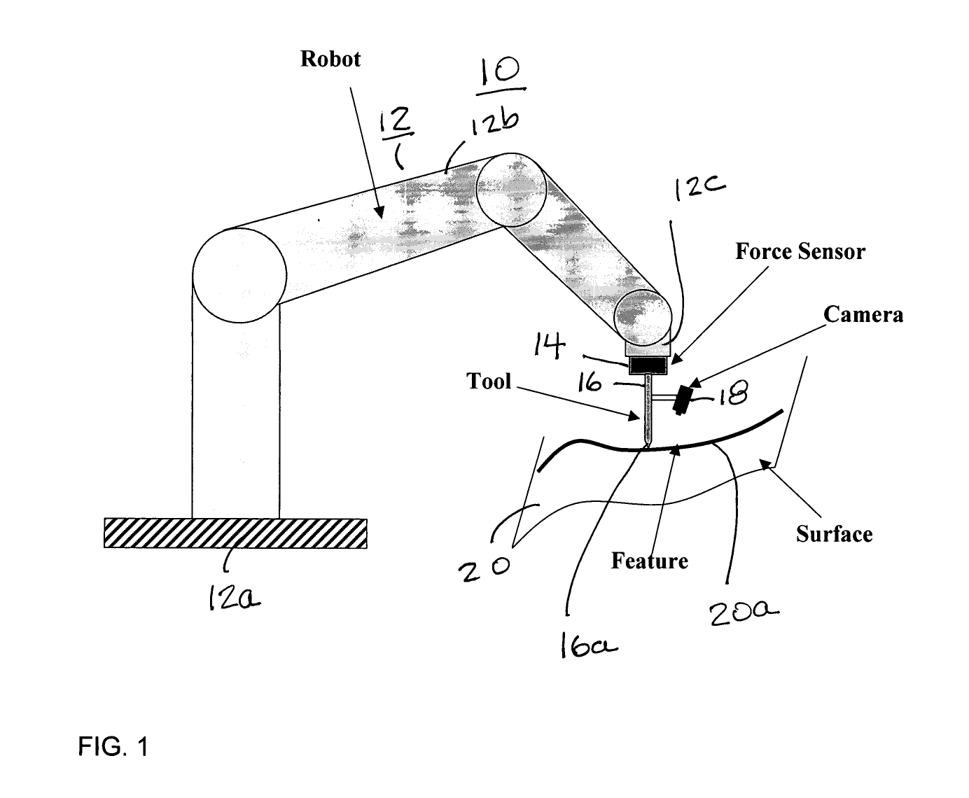

FIG. 1 illustrates an example system 10 where the method of the present invention can be employed. The system 10 includes a robot 12 that has a robot base 12a and a moveable arm assembly 12b supported on the base 12a. The end 12c of the arm 12b supports a 1-DOF force sensor 14, which in turn supports a tool 16 that is used to perform a desired operation on a stationary work piece 20, and a camera 18. The camera 18 is located preferably so that the tool center point (TCP) 16a is in the middle of the image seen by the camera 18. The tool 16 performs an operation such as, for example, welding, polishing or deburring on the work piece 20 by following a desired path on the work piece 20. The desired path is shown in FIG. 1 by the marked feature 20a on the surface of work piece 20. The robot 12 learns the desired path in accordance with the present invention.

While FIG. 1 shows a moving tool 16 and a stationary work piece 20, it should be appreciated that the present invention can also be used when the end 12 of the arm 12a supports the work piece 20 while the tool 16 and camera are stationary. Further, while the present invention is described above in connection with operations such as welding, polishing and deburring it can also be used with other operations performed by a robot, such as, for example stripe painting.

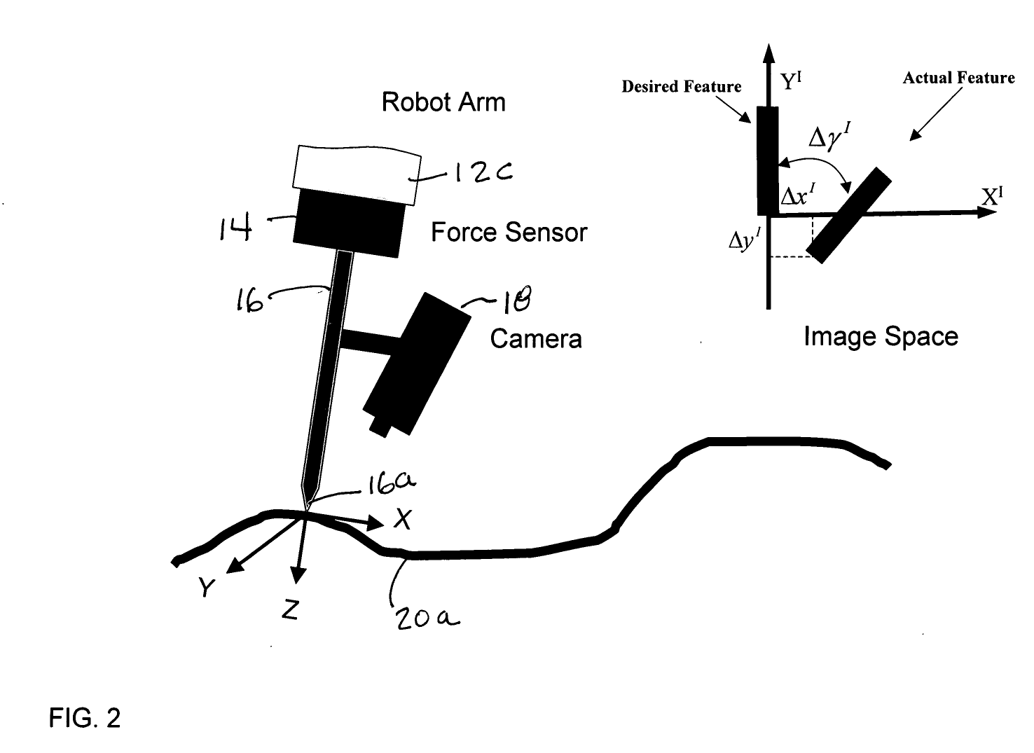

In accordance with the vision-force-servo control method of the present invention a controller, not shown in FIG. 1, controls the movement of the robot arm 12b based on 1) the input of the force sensor 14; 2) the error in the image coordinate system between the TCP 16a and the marked feature 20a on the work piece surface; and 3) the curvature of the immediately available path calculated based on the recorded movement of the robot when it follows the marked path. The vision-force-servo control method of the present invention is illustrated in detail in FIG. 2 to FIG. 8.

As is well known, a camera 18 is a two dimensional imaging device that can easily and accurately provide two dimensional information. As described in the prior art such as the '425 Patent, there have been numerous attempts to construct three dimensional information based on the 2-D image and these attempts resulted in a complex and costly system. The present invention uses a 2-D imaging device, such as camera 18, for 2-D purposes only. As shown in FIG. 2, the movement of the robot arm 12a and thus the tool 16 in the x and y direction \dot{x}, \dot{y} is controlled by the error Δx^{I}, Δy^{I} between the TCP 16a and the marked feature 20a in the image space.

The third degree of freedom, the robot movement in the Z direction, ż, is controlled by the force feedback F_{z} from the force sensor 14 to maintain a constant and continuous contact between the tool 16 and the work piece 20. This controlled degree of freedom together with the controlled robot movement in the x and y directions causes the TCP trajectory to follow the exact location (x, y, z) coordinates of the desired path. Compared to the methods described in the prior art, the camera 18 is not used as a 3-D metrology device. In the present invention, the camera 18 is used only as a 2-D feedback device only for obtaining the x and y dimensions. The third dimension, z, is obtained by feedback control using force sensor 14.

In many applications such as grinding and deburring, giving the (x, y, z) coordinates is not sufficient for the robotic process, in that the tool 16 has to maintain a desirable orientation relative to the work piece surface. To acquire all 6-DOF coordinates, the orientation roll \dot{γ} is controlled as is shown in FIG. 2 by the angle Δγ^{I} of the marked feature 20a relative to the image coordinate system, i.e., the tool coordinate system.

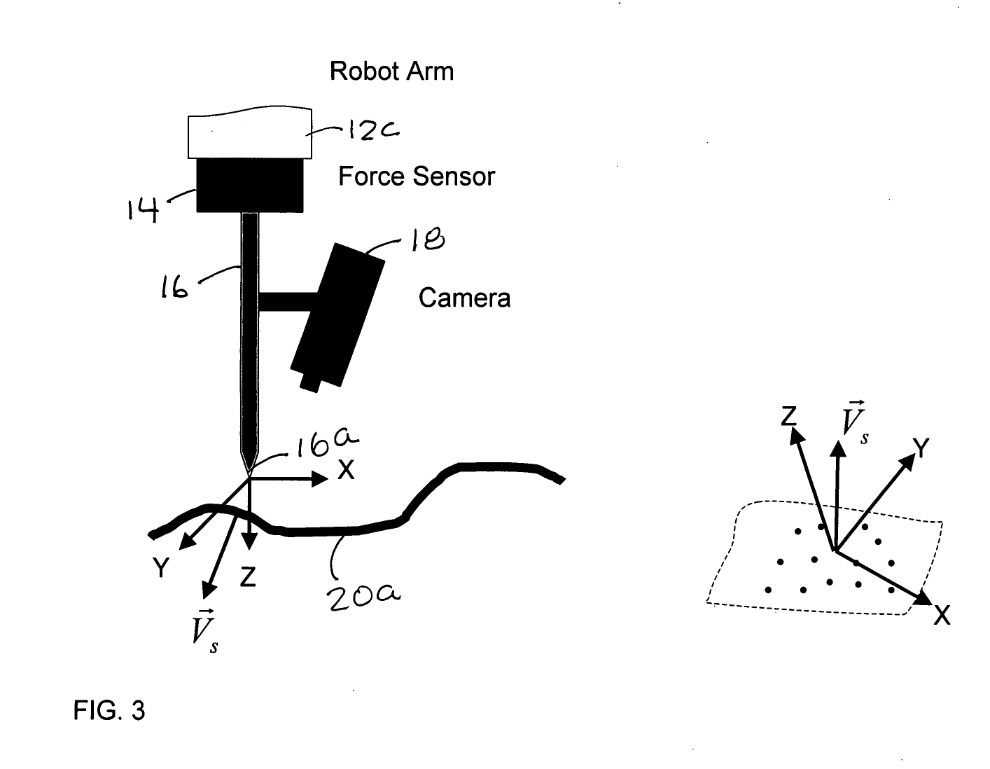

As shown in FIG. 3, the other two orientations, pitch β and yaw α, are obtained differently, based on the already recorded position data Xᵢ^{P}, where:

$${X}_{i}^{P} = {[ \begin{matrix}{x}_{i} \\ {y}_{i} \\ {z}_{i}\end{matrix} ]}_{i = 1 … n}$$

### There are, as is described in more detail below, two methods to obtain the two orientations, pitch and yaw.

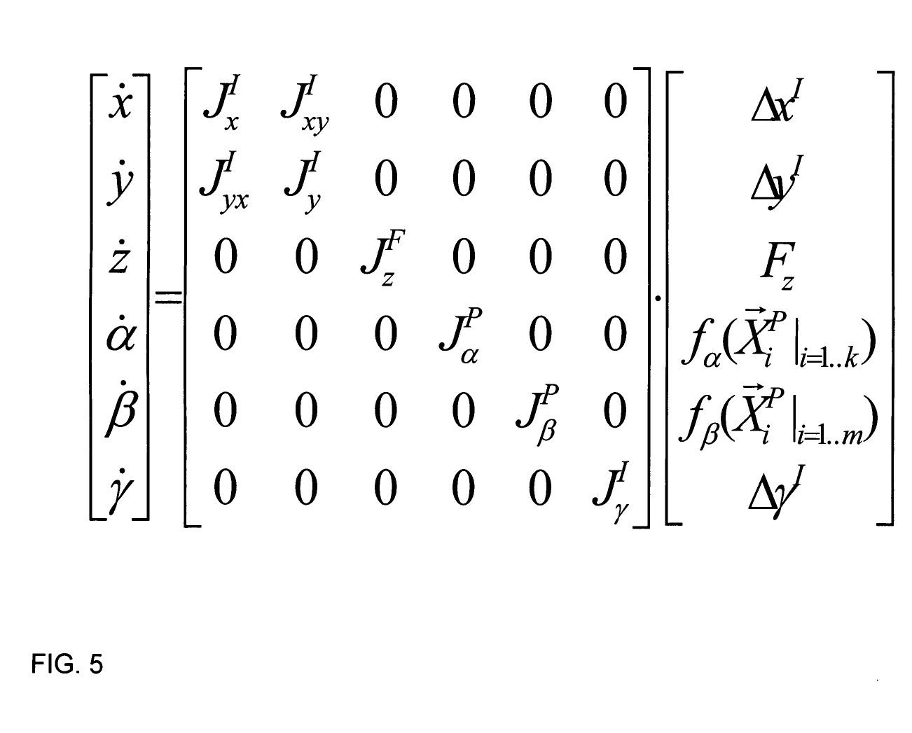

For each position of tool 16, neighboring points are found to generate a normal direction \vec{V}ₛ of the surface of work piece 20. The normal direction is the tool direction. Thus the tool 16 is always perpendicular to the surface of work piece 20. FIG. 5 shows the mathematical expression of the control method to transfer the actual position or orientation errors into the robot velocity in the tool coordinate frame. In that expression, the error Δx^{I}, Δy^{I} in the right hand vector are determined from camera 18 and the force feedback F_{z} in that vector is determined from the force sensor 14. The three remaining terms in that vector are determined from the robot orientation.

The methods to obtain the two orientations, pitch and yaw, are now described in detail.

Method 1:

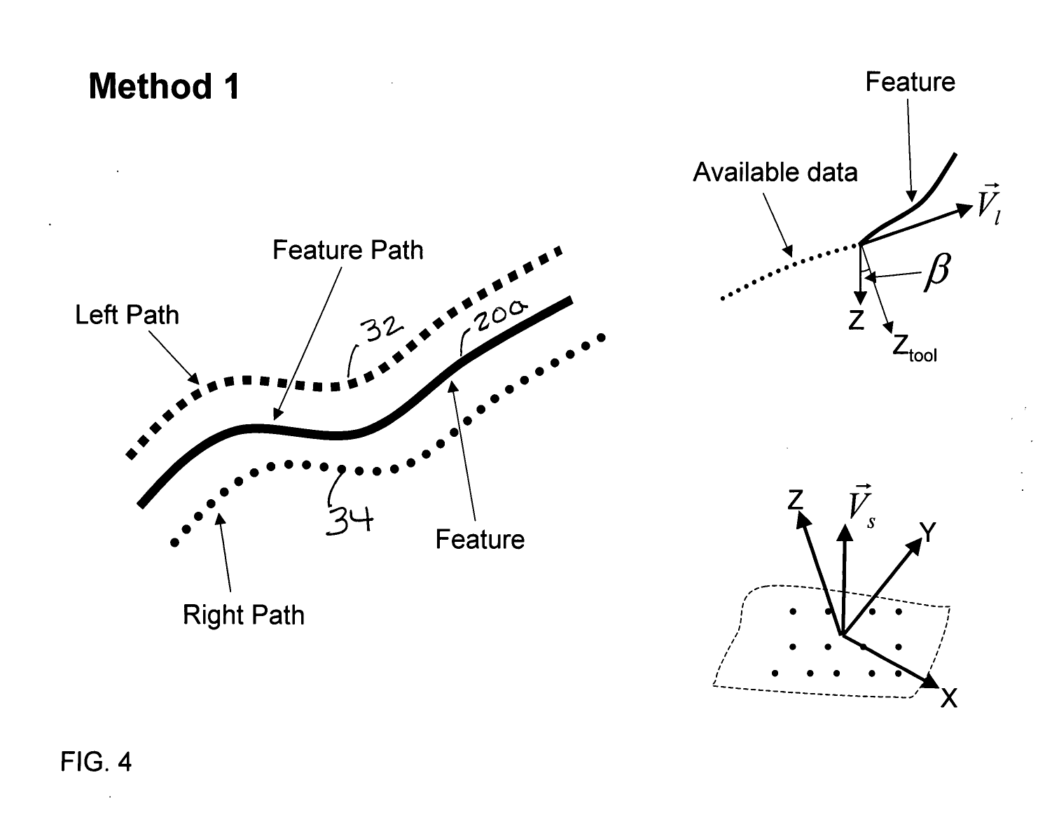

The robot is first controlled to follow the feature path 20a shown in FIG. 4a on work piece 20. The movement in pitch \dot{β} is controlled using the available position data by computing the vector \vec{V}ₗ in relation to the path coordinate system so that as shown in FIG. 4b, \vec{Z}ₜₒₒₗ ⊥\vec{V}ₗ.

The robot is then controlled by offsetting the feature path 20a a certain distance on either side of that feature giving rise as shown in FIG. 4a to the left path 32 and right path 34 of the feature path. In one embodiment for the present invention, the offset of paths 32 and 34 from path 20a were each selected to be identical and was programmed in the controller for robot 12 to be half width of the marked feature 20a. This value for the offset was chosen so that the left and right paths 32, 34 were substantially within the local area of the feature 20a. After the position data are obtained by following the feature path 20a and then following each of the left path 32 and the right path 34 in their entirety, the robot 12 is controlled to follow the feature path 20a again. For each tool position, the pitch and yaw velocity (\dot{α} and \dot{β}) are calculated by finding the normal direction \vec{V}ₛ of a plane, which is formed by the neighboring points.

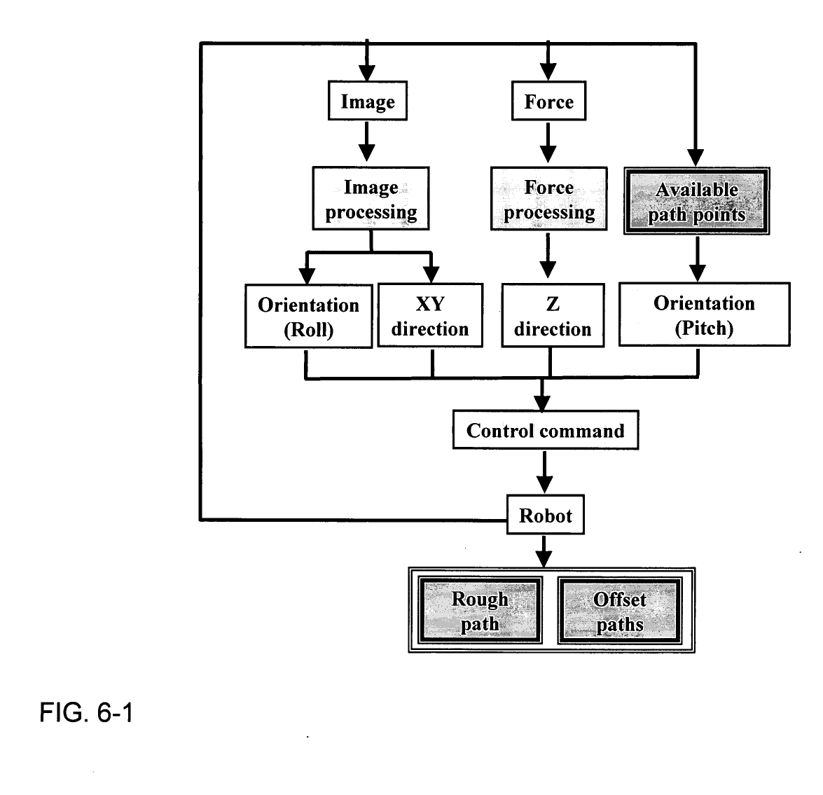

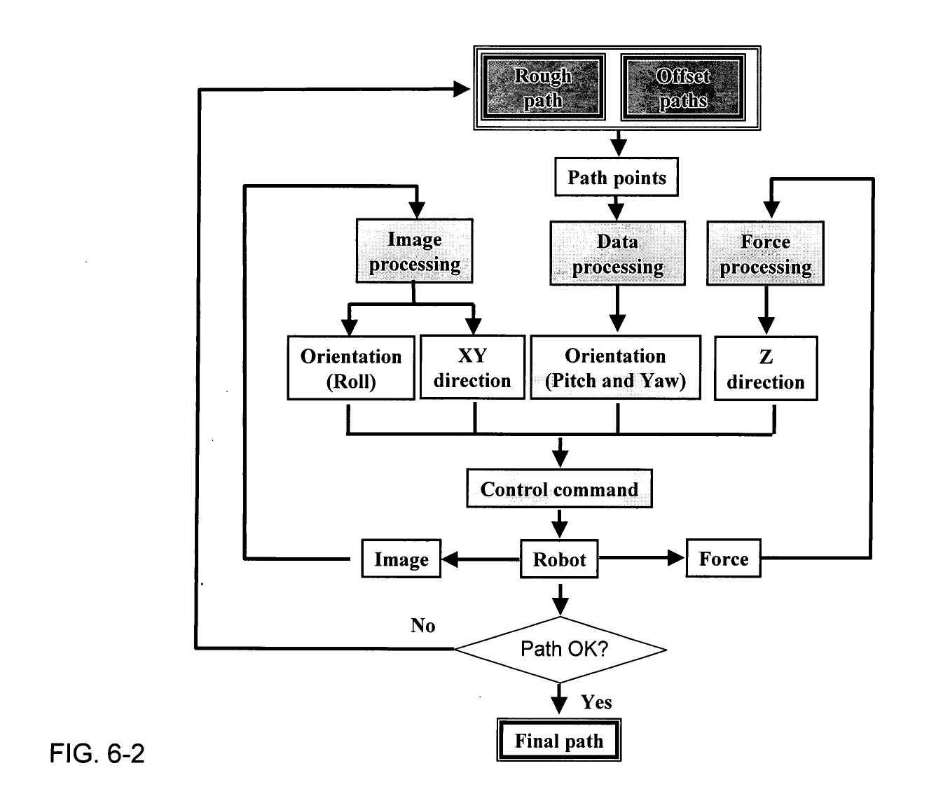

Referring now to FIGS. 6-1 and 6-2 there are shown control diagrams that illustrate in detail the process described above. The control diagram of FIG. 6-1 illustrates the first step of the process which is the generation of first the rough path and then the offset paths. The control diagram of FIG. 6-2 illustrates the second step of the process which is the generation of the final path.

Referring now to FIG. 6-1, in the first step of the process, which is first the generation of the rough path and then the generation of the offset paths, the tool 16 is maintained at a constant force and in continuous contact with the work piece 20. After processing of the image from camera 18 using the captured images, \dot{x}, \dot{y} and \dot{γ} can be calculated and used to control the robot 12. The pitch \dot{β} is obtained based on the recorded data which are the available path points obtained from following feature path 20a. Because the yaw orientation is not controlled, this first part of the first step is known as the rough path generation. The tool is then offset a certain distance to the feature path 20a in the image frame to obtain the offset paths 32 and 34.

Referring now to FIG. 6-2, in the second step in the process, which is the final path generation, from the rough and offset paths, the surface normal at each point on the feature can be computed by fitting a plane to the neighboring points obtained in the first step. The pitch velocity \dot{α} and the yaw velocity \dot{β} can then be determined when the tool moves along the feature path 20a. At each tool position, the orientation (roll γ, pitch α and yaw β) is controlled first until it reaches the desired value.

The X position in the image frame is then controlled to reach the center of the feature path 20a. Once the tool 16 is at the center of the feature, the point is the final path point and recorded. The robot 12 is then controlled along the Y direction and moved to the next point. The process continues until a path is generated.

Method 2:

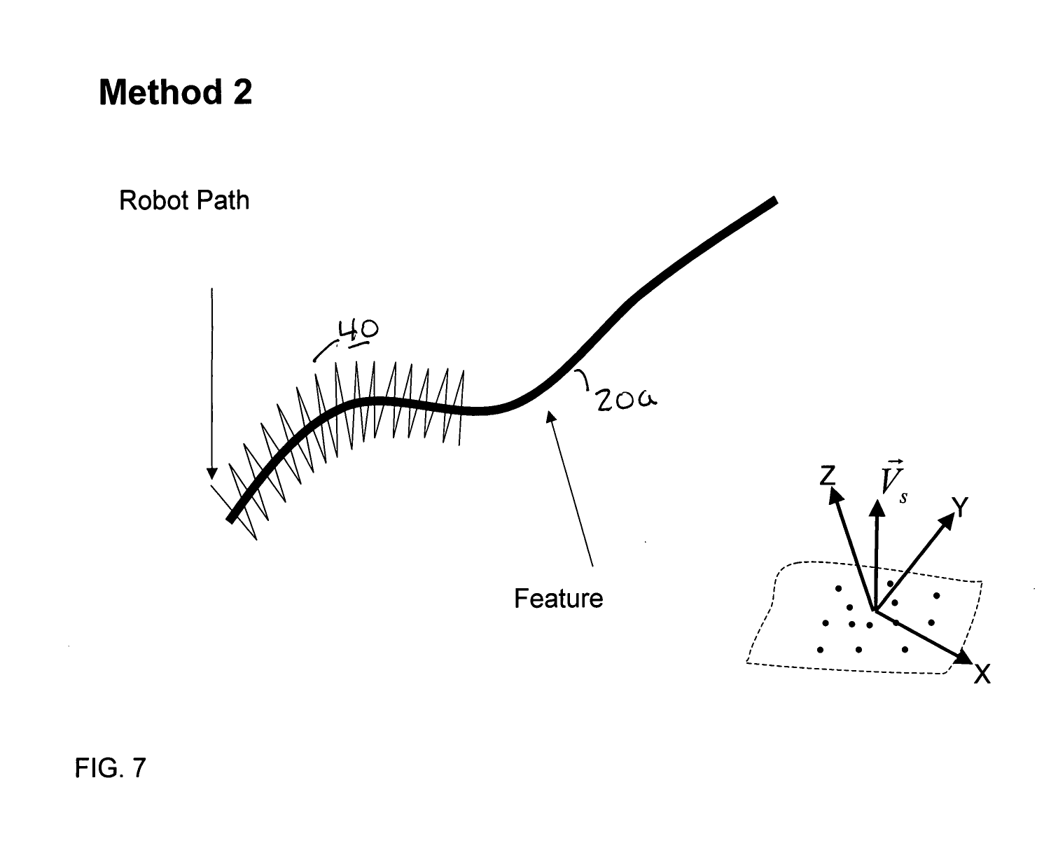

In order to calculate the surface curvature of the feature path 20a, the robot 12 is controlled to follow a zig-zag pattern 40 as shown in FIG. 7 or other path patterns such as a sine wave pattern. For each tool position on the feature path 20a, the pitch and yaw velocity (\dot{α} and \dot{β}) are calculated by finding the normal direction \vec{V}ₛ of a plane, which is formed by the available points. If accurate orientation control is needed, the robot 12 is controlled to follow the contour of the feature path 20a again to obtain accurate pitch and yaw orientation. At each tool position, the pitch and yaw orientation is controlled to reach their desired values before the XY position is changed.

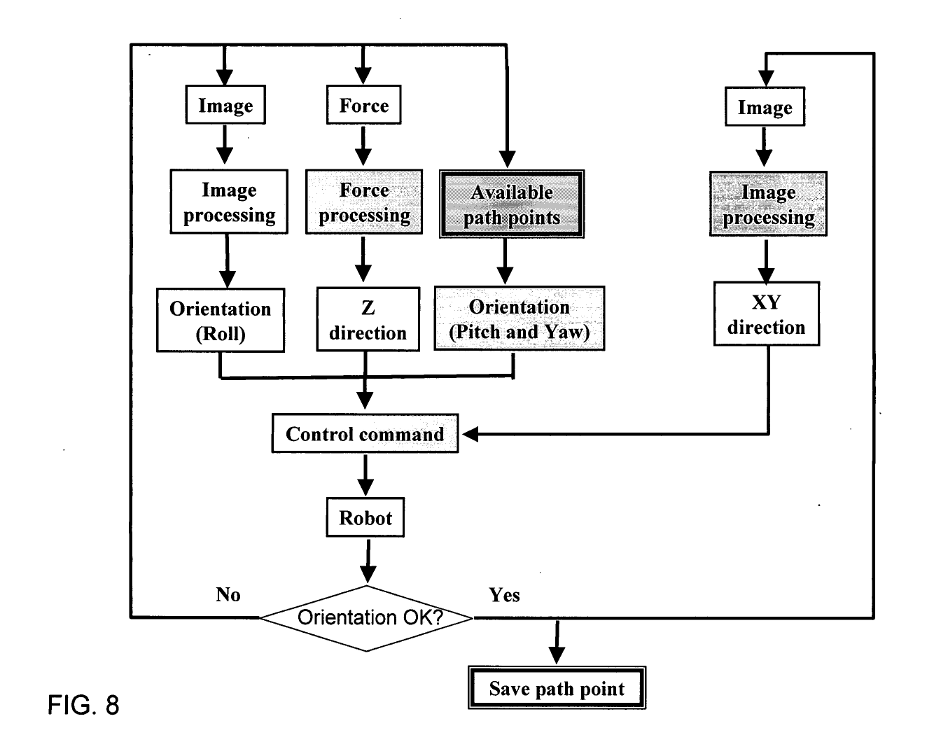

Referring now to FIG. 8, there is shown the control diagram that illustrates the process described above that calculates the surface curvature of feature path 20a.

The tool 16 is maintained at a constant force and in continuous contact with the work piece 20. After image processing using the captured images from camera 18, \dot{x}, \dot{y} and \dot{γ} can be calculated and used to control the robot 12 to follow the zig-zag pattern 40. When the tool 16 is at the center of the feature 20a, the robot 12 stops moving along the XY direction. The orientation \dot{α} and \dot{β} are computed by finding the normal of the fitted plane using the recorded data. The orientation is controlled until it reaches its desired value. The X position is then corrected until the tool 12 is at the center of the feature. The point (path point) is then recorded. The robot 12 moves again to follow the zig-zag pattern 40 until the tool 16 reaches the center of the feature. The process continues until a path is generated.

With the method described above, all six degree of freedom coordinates in the three dimensional space can be obtained in the following sequence:

Step 1: The desired path on the work piece 20 is visibly marked.

Step 2: With the tool 16 in contact with the work piece 20, under the vision-force-servo method described above, the tool TCP 16a is moving along the desired path, with 6-DOF coordinates resolved.

The above method can be applied to make a robot 12 program itself, without using the imaging device, for example camera 18, for metrology and avoids the high cost/requirements associated with using the imaging device for metrology. Using the 2-D imaging device only for deriving 2-D information for feedback purpose that eliminates the high accuracy requirements for imaging device itself as well as the stringent calibration between the 2-D camera space and 3-D robot workspace for metrology purpose.

It should be appreciated that the program developed for the robot using the method and apparatus of the present invention may be for the tool tip to follow a path on a workpiece that is either new in the sense that the desired feature path was not known before to the robot or is slightly different than a path previously followed by the tool tip on another workpiece that is the same as or substantially identical to the workpiece on which work is now to be performed where the differences between the path to be followed on that workpiece and the path that was followed on an earlier workpiece are due for example to variations between the workpieces. Thus in the former case the computing device that receives the information from the camera and force sensor in accordance with the present invention to develop a program that allows the tool tip to follow that is “new” as described above whereas in the latter case the computing device uses that information to make the necessary modifications to a preexisting program for movement of the tool tip when it is to perform work on the workpiece.

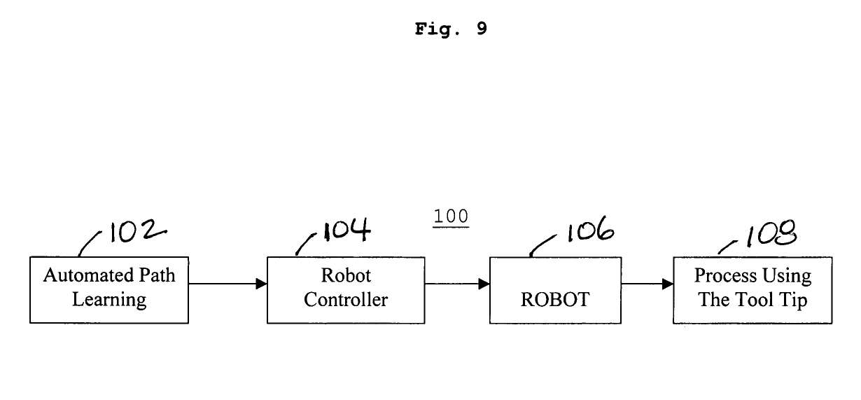

Referring now to FIG. 9, there is shown a system 100 which may be used to implement the automated path learning method of the present invention described above.

The system 100 includes that method 102 in the form of software that is on a suitable media in a form that can be loaded into the robot controller 104 for execution. Alternatively, the method can be loaded into the controller 104 or may be downloaded into the controller 104, as described above, by well known means from the same site where controller 104 is located or at another site that is remote from the site where controller 104 is located. As another alternative, the method 102 may be resident in controller 104 or the method 102 may installed or loaded into a computing device (not shown in FIG. 9) which is connected to controller 104 to send commands to the controller.

As can be appreciated by those of ordinary skill in the art, when the method is implemented in software in controller 104, the controller functions as a computing device to execute the method 102. The controller 104 is connected to robot 106 which in turn is used to perform the process 108 that uses the tool tip. Thus if the method 102 is executed by controller 104 or if the controller 104 receives commands from a computing device that executes the method 102 the robot 106 is controlled to perform the process 108 in accordance with the present invention. It should be appreciated that the adaptive PI control method 102 can be implemented on the robot controller 104 as a software product, or implemented partly or entirely on a remote computer, which communicates with the robot controller 104 via a communication network, such as, but not limited to, the Internet.

The various features and advantages for the present invention become apparent to those skilled in the art from the above detailed description of the preferred embodiment.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A system for programming a robot so that a tool having a tip can follow a desired path visibly marked on a workpiece when said tool is to perform work on said workpiece comprising:
a force sensor;
a camera oriented to view said visibly marked desired path; and
a computing device associated with said robot;
said force sensor and said camera each providing information to said computing device when said tool tip is in controlled contact with an area of said workpiece that includes said desired path, said computing device using said information to develop a program for motion of said robot that causes said tool tip to follow said desired path when said tool is to perform work on said workpiece.

2. The system of claim 1 wherein said robot holds said tool in a manner such that said tool is caused to move in relation to said workpiece when said tool is to perform work on said workpiece and said camera is mounted on said robot in a manner to move with said tool.

3. The system of claim 1 wherein said tool and said camera are stationary and said robot holds said workpiece in a manner such that said workpiece is caused to move in relation to said tool when said tool is to perform work on said workpiece.

4. The system of claim 1 wherein said force sensor is mounted on said robot.

5. A method for programming a robot so that a tool having a tip can follow a desired path visibly marked on a workpiece when said tool is to perform work on said workpiece comprising:
using an image of a point on said desired path when said tool tip is on said desired path and one or more other points related to said point on said desired path when said tool tip is in controlled contact with an area on said workpiece that includes said desired path to determine a predetermined number of degrees of freedom information for said point on said desired path;
repeating said step above to determine said predetermined number of degrees of freedom information for one or more other points on said desired path; and
developing from said determined predetermined number of degrees of freedom information for said point on said desired path and each of said one or more other points on said desired path a program for motion of said robot that allows said tool tip to follow said desired path when said tool is to perform work on said workpiece.

6. The method of claim 5 wherein said one or more other points related to said point on said desired path are obtained by causing said tool tip to follow a first path which is an offset of said desired path on one side of said desired path and a second path which is an offset of said desired path on another side of said desired path.

7. The method of claim 6 wherein said offset of each of said first and second paths is identical.

8. The method of claim 5 wherein said one or more other points related to said point on said desired path are obtained by causing said tool tip to follow a predetermined pattern that crosses said desired path from one side to another side of said desired path.

9. The method of claim 5 further comprising bringing said tool tip in said controlled contact with said workpiece.

10. A method for programming a robot so that a tool having a tip can follow a desired path visibly marked on a workpiece when said tool is to perform work on said workpiece comprising:
determining from an image of each of a plurality of points on said desired path when said tool tip is on said desired path and is in controlled contact with said workpiece the X, Y and Z locations of each of said plurality of points on said desired path and the roll angle of said tool with said desired path at each of said plurality of points;
using each of said plurality of points on said desired path and one or more other points related to each of said plurality of points on said desired path when said tool tip is in controlled contact with an area on said workpiece related to said desired path to determine the pitch and yaw angles of said tool with said desired path for each of said plurality of points on said desired path; and
developing from said X, Y and Z locations and said roll, pitch and yaw angles for each of plurality of points on said desired path a program for motion of said robot that allows said tool tip to follow said desired path when said tool is to perform work on said workpiece.

11. The method of claim 10 wherein said one or more other points related to said each of said plurality of points on said desired path are obtained by causing said tool tip to follow a first path which is an offset of said desired path on one side of said desired path and a second path which is an offset of said desired path on another side of said desired path.

12. The method of claim 11 wherein said offset of each of said first and second paths is identical.

13. The method of claim 10 wherein said one or more other points related to each of said one or more other points on said desired path are obtained by causing said tool tip to follow a predetermined pattern that cyclically crosses said desired path from one side to another side of said desired path.

14. A computer program product for programming a robot so that a tool having a tip can follow a desired path visibly marked on a workpiece when said tool is to perform work on said workpiece, comprising:
a computer-readable medium having instructions for causing a computer to execute a method comprising:
using an image of a point on said desired path when said tool tip is on said desired path and one or more other points related to said point on said desired path when said tool tip is in controlled contact with an area on said workpiece that includes said desired path to determine a predetermined number of degrees of freedom information for said point on said desired path;
repeating said step above to determine said predetermined number of degrees of freedom information for one or more other points on said desired path; and
developing from said determined predetermined number of degrees of freedom information for said point on said desired path and each of said one or more other points on said desired path a program for motion of said robot that allows said tool tip to follow said desired path when said tool is to perform work on said workpiece.

15. A computer program product for programming a robot so that a tool having a tip can follow a desired path visibly marked on a workpiece when said tool is to perform work on said workpiece, comprising:
a computer-readable medium having instructions for causing a computer to execute a method comprising:
determining from an image of each of a plurality of points on said desired path when said tool tip is on said desired path and is in controlled contact with said workpiece the X, Y and Z locations of each of said plurality of points on said desired path and the roll angle of said tool with said desired path at each of said plurality of points;
using each of said plurality of points on said desired path and one or more other points related to each of said plurality of points on said desired path when said tool tip is in controlled contact with an area on said workpiece related to said desired path to determine the pitch and yaw angles of said tool with said desired path for each of said plurality of points on said desired path; and
developing from said X, Y and Z locations and said roll, pitch and yaw angles for each of plurality of points on said desired path a program for motion of said robot that allows said tool tip to follow said desired path when said tool is to perform work on said workpiece.

16. A system for programming a robot so that a tool having a tip can follow a desired path visibly marked on a workpiece when said tool is to perform work on said workpiece, said system comprising:
a computing device having therein program code usable by said computing device, said program code comprising:
code configured to use an image of a point on said desired path when said tool tip is on said desired path and one or more other points related to said point on said desired path when said tool tip is in controlled contact with an area on said workpiece that includes said desired path to determine a predetermined number of degrees of freedom information for said point on said desired path;
code configured to repeat said step above to determine said predetermined number of degrees of freedom information for one or more other points on said desired path; and
code configured to develop from said determined predetermined number of degrees of freedom information for said point on said desired path and each of said one or more other points on said desired path a program for motion of said robot that allows said tool tip to follow said desired path when said tool is to perform work on said workpiece.

17. A system for programming a robot so that a tool having a tip can follow a desired path visibly marked on a workpiece when said tool is to perform work on said workpiece, said system comprising:
a computing device having therein program code usable by said computing device, said program code comprising:
code configured to determine from an image of each of a plurality of points on said desired path when said tool tip is on said desired path and is in controlled contact with said workpiece the X, Y and Z locations of each of said plurality of points on said desired path and the roll angle of said tool with said desired path at each of said plurality of points;
code configured to use each of said plurality of points on said desired path and one or more other points related to each of said plurality of points on said desired path when said tool tip is in controlled contact with an area on said workpiece related to said desired path to determine the pitch and yaw angles of said tool with said desired path for each of said plurality of points on said desired path; and
code configured to develop from said X, Y and Z locations and said roll, pitch and yaw angles for each of plurality of points on said desired path a program for motion of said robot that allows said tool tip to follow said desired path when said tool is to perform work on said workpiece.
